(19) United States
(12) Patent Application Publication
(10) Pub. No.: US 2010/0330224 A1
(43) Pub. Date: Dec. 30, 2010

(54) SHAPING MOLD OF BUSHING BASE

(75) Inventor: Mark HUNG, Lukang (TW)

Correspondence Address: RABIN & Berdo, PC, 1101 14TH STREET, NW, SUITE 500, WASHINGTON, DC, 20005, US

(73) Assignee: RED WOOD ENTERPRISE CO., LTD, Changhua Shien (TW)

(21) Appl. No.: 12/491,476

(22) Filed: Jun. 25, 2009

(51) Int. Cl. B29C 45/36

(52) U.S. Cl. 425/542

(57) ABSTRACT

A shaping mold of a bushing base includes a bottom die and a core integrally made of a heat-resistant plastic material. A cavity in a predetermined shape is formed at the bottom die and provided for accommodating the core with an appropriate predetermined gap, such that the core and the cavity can be engaged or disengaged with one another by turning. A low-temperature shaping material such as silicone or polyurethane (PU) foam is injected into the gap between the cavity and the core for integrally forming the bushing base in a predetermined shape. The invention can lower the cost of the shaping mold of the bushing base significantly, and provide a smooth fine surface of the molded bushing base.

### BACKGROUND OF THE INVENTION

1. Field of the Invention

The present invention relates to a shaping mold, and more particularly to a shaping mold made of a heat-resistant plastic material, and capable of injecting a low-temperature shaping material such as silicone or PU foam into the mold for forming various bushing bases.

2. Description of the Related Art

In general, conventional bushing bases, particularly those used for filters of motor vehicles or motorcycles, or those used for connecting intake tubes are made of a rubber material and formed by a metal mold. Since the bushing bases made of a rubber material comes with a hard structure, therefore the bushing bases may be hardened, embrittled or deformed easily, and such bushing bases cannot be fastened by a binder easily, and thus related manufacturers use a low-temperature shaping material such as silicone or PU foam to replace the rubber material, while still using the metal mold.

### SUMMARY OF THE INVENTION

In general, a metal mold is usually applied for molding a high-temperature shaping material, and thus the way of forming a bushing base made of a low-temperature shaping material such as silicone or PU foam by using a metal mold is not a good choice, since the molding technology for making metal shaping molds and the metal incur a high cost, and thus a metal mold is expensive. Particularly for mass productions that require a lot of molds, and thus the production cost will be increased significantly, which is not cost-effective for manufacturers. Furthermore, the metal mold has a greater specific gravity, and involves a complicated structural design of closing the mold due to the limitation of the characteristics of the metal material, and the manufacture of metal mold requires greater power for the operating equipments. Since the metal shaping mold is made by a general metal manufacturing, the surface of the cavity of a closed mold still has manufacturing lines, such that the surface of the formed bushing base has obvious rough lines and fails to provide a smooth fine surface for the aesthetic effect, which definitely will affect the add-on-value of the product.

It is a primary objective of the present invention to provide a shaping mold of a bushing base, and the shaping mold comprises a bottom die and a core integrally made of a heat-resistant plastic material. A cavity in a predetermined shape is formed at the bottom die and provided for accommodating the core with an appropriate predetermined gap, such that the core and the cavity can be engaged or disengaged with one another by turning. A low-temperature shaping material such as silicone or polyurethane (PU) foam is injected into the gap between the cavity and the core for integrally forming the bushing base in a predetermined shape.

Compared with the conventional metal molds, the plastic shaping mold for forming a bushing base in accordance with the present invention can lower the cost of the shaping mold of the bushing base significantly, and provide a smooth fine surface of the molded bushing base without leaving any rough manufacturing lines.

### BRIEF DESCRIPTION OF THE DRAWINGS

FIG. 1 is a perspective view of a shaping mold in accordance with a preferred embodiment of the present invention;

FIG. 2 is an exploded view of the present invention;

FIG. 3 is a cross-sectional view of the present invention;

FIG. 4 is a schematic view of passing a positioning block of a core into a positioning groove of a bottom die in accordance with the present invention;

FIG. 5 is a schematic view of turning a positioning block of a core out of a positioning groove of a bottom die in accordance with the present invention;

FIG. 6 is a cross-sectional side view of injecting silicone in accordance with the present invention;

FIG. 7 is a cross-sectional side view of putting in a filter in accordance with the present invention;

FIG. 8 is a schematic view of removing a core after a bushing base is molded in accordance with the present invention;

FIG. 9 is a cross-sectional side view of forming a cover in accordance with the present invention; and

FIG. 10 is a perspective view of a filter with a cover in accordance with the present invention.

### DETAILED DESCRIPTION OF THE PREFERRED EMBODIMENTS

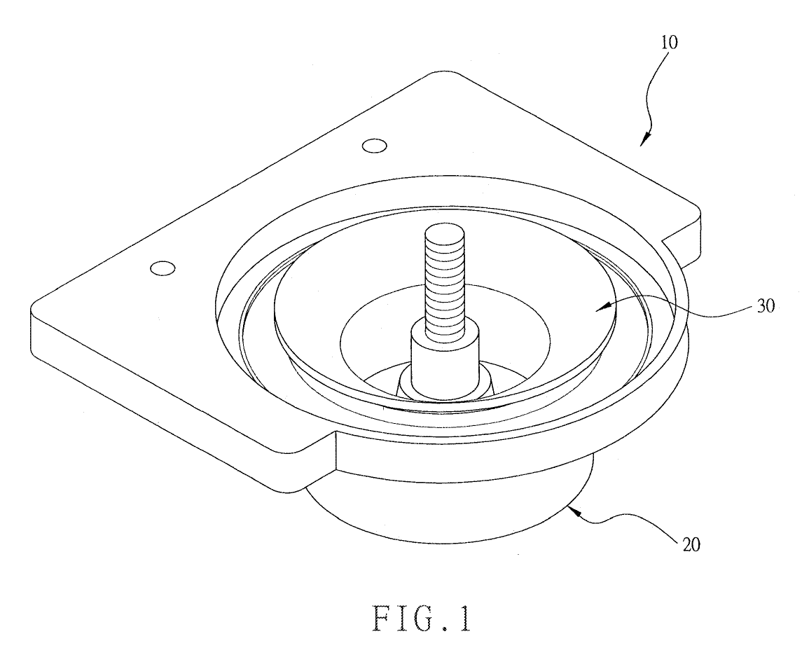

With reference to FIG. 1 for a shaping mold in accordance with a preferred embodiment of the present invention, the shaping mold used for forming a bushing base for a filter of motor vehicles or motorcycles is used for illustrating the invention. The shaping mold 10 comprises a bottom die 20 and a core 30.

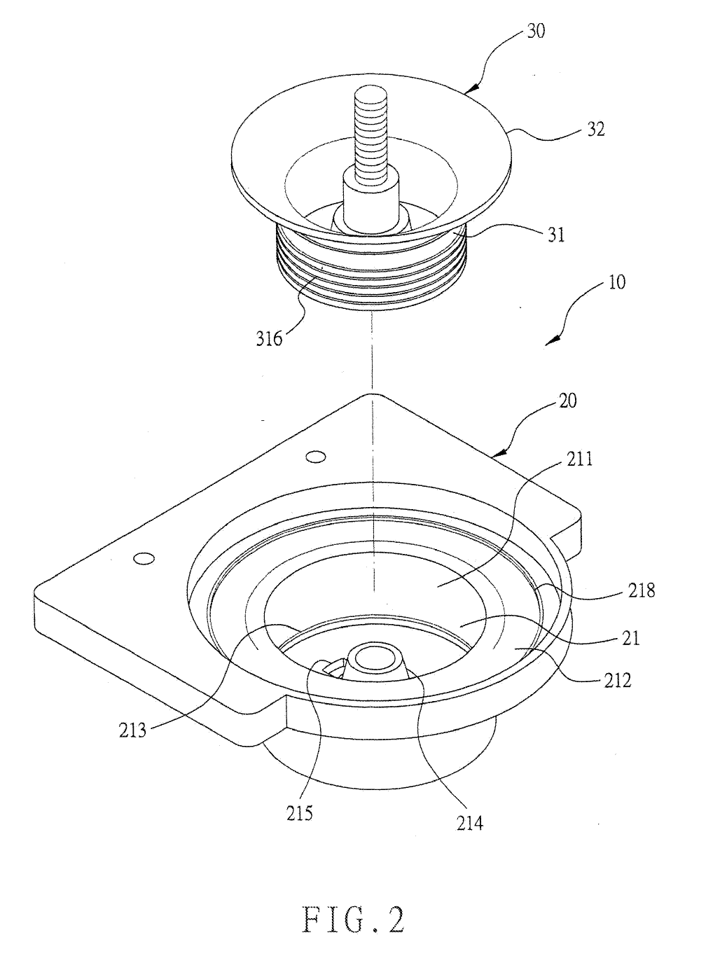

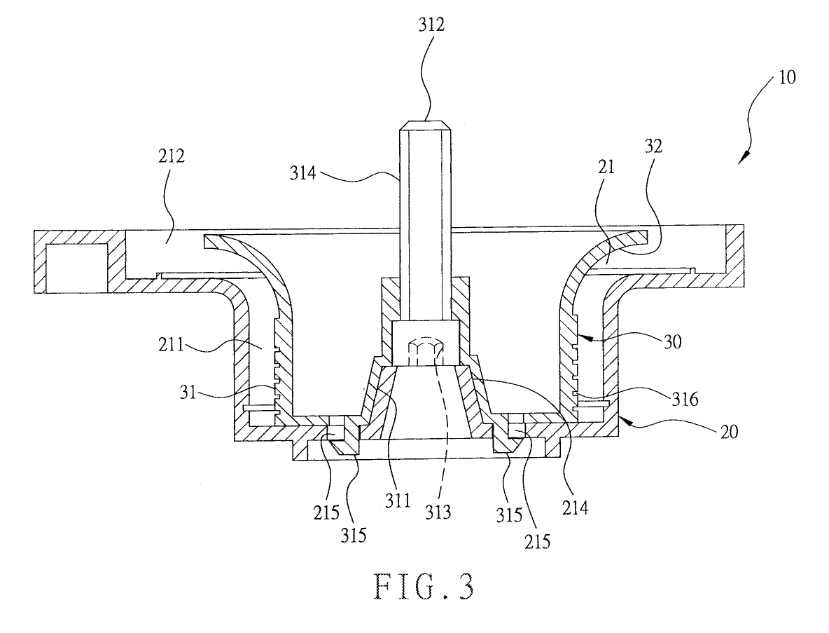

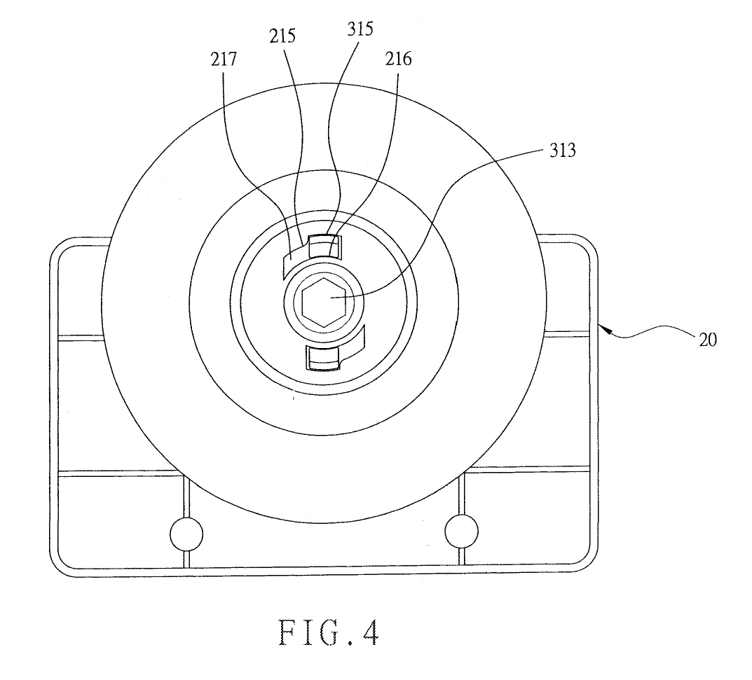

In FIGS. 2 and 3, the bottom die 20 integrally formed by a heat-resistant plastic material includes a cavity 21 in the shape of a circular groove and concavely disposed on the bottom die 20. The cavity 21 includes a tube cavity 211 disposed at the center of the cavity 21 and a cover cavity 212 extended from an opening of the tube cavity 211 and having a larger diameter than the tube cavity 211, wherein the tube cavity 211 includes a circular stop groove 213 concavely disposed around the periphery and proximate to the bottom of the tube cavity 211, a tubular mold pillar 214 protruded from the center of the bottom of the tube cavity 211. In addition, two symmetrical hollow positioning grooves 215 disposed at the bottom of the periphery of the tubular mold pillar 214, and each positioning groove 215. With reference to FIG. 4 together, the positioning grooves 215 form a penetrating ditch 216 with a wider section and a turn-to-snap slot 217 with a narrower section, and a circular flange 218 is protruded from a bottom edge of the cover cavity 212.

The core 30 formed integrally by a heat-resistant plastic material includes a cylindrical tubular mold pillar 31, a greater-diameter arc cover mold plate 32 extended outwardly from the top of the tubular mold pillar 31, a containing opening 311 concavely disposed at the center of the bottom of the tubular mold pillar 31, a bolt 312 embedded or integrally formed at the center of the containing opening 311, a hexagonal bolt hole 313 formed at bottom of a bolt 312 and precisely disposed at the center of the bottom of the containing opening 311, and a bolt 314 at the top extended upwardly to a hollow portion at the top of the tubular mold pillar 32. Two symmetrical positioning blocks 315 are extended downwardly from the periphery of the containing opening 311, and each positioning block 315 is in a form of a claw, and a predetermine number of circular anti-skid grooves 316 are formed on an internal wall of the tubular mold pillar 31, such that when the core 30 is installed into the cavity 21 of the bottom die 20, the tubular mold pillar 31 and the cover mold plate 32 can be accommodated precisely and respectively into the spaces with predetermined sizes of the tube cavity 211 and the cover cavity 212, and the containing opening 311 of the tubular mold pillar 31 can be precisely sheathed onto the tubular mold pillar 214 at the center of the tube cavity 211 to expose the bottom. In the meantime, the two positioning blocks 315 at the bottom of the tubular mold pillar 31 can be passed through the penetrating ditch 216 with a wider section as shown in FIG. 4, and timely turned and snapped into the turn-to-snap slot 217 with a narrower section.

The description above shows the structure, the position, the connecting relation of each element of the shaping mold of the invention, and the operation and expected effects of the invention will be described as follows.

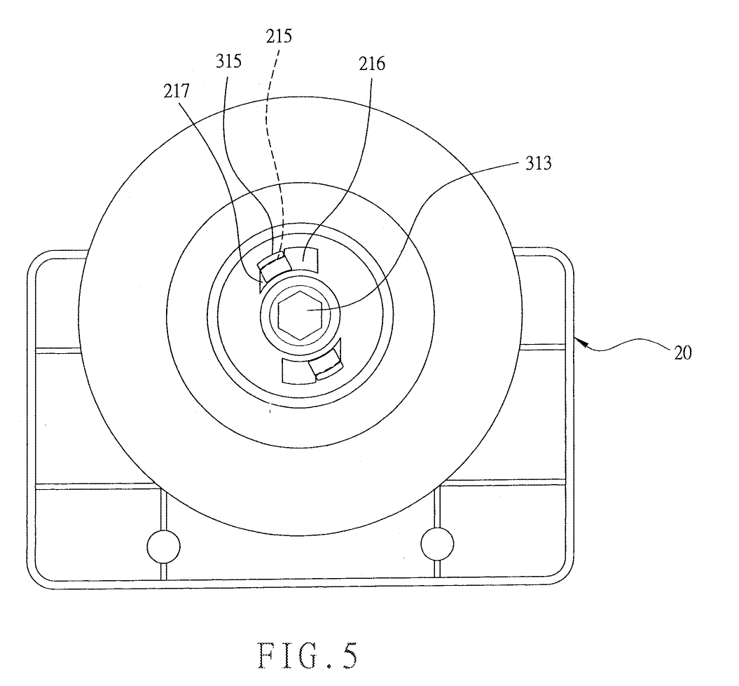

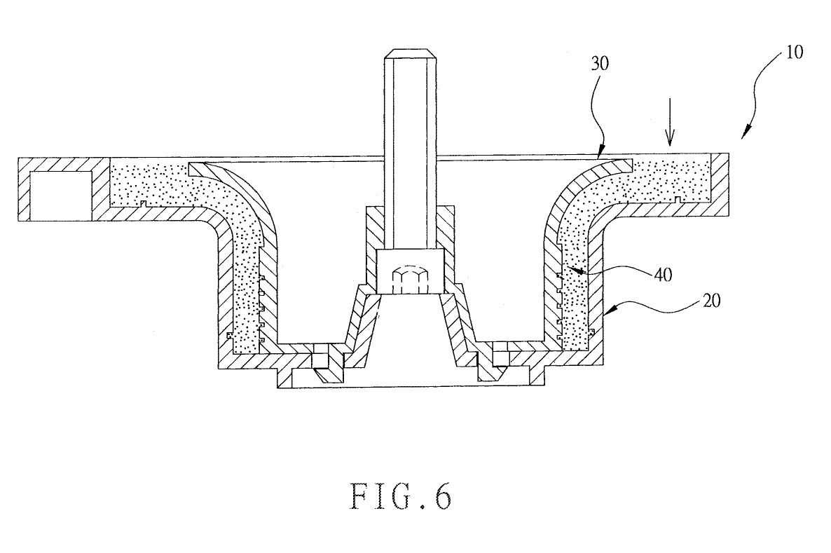

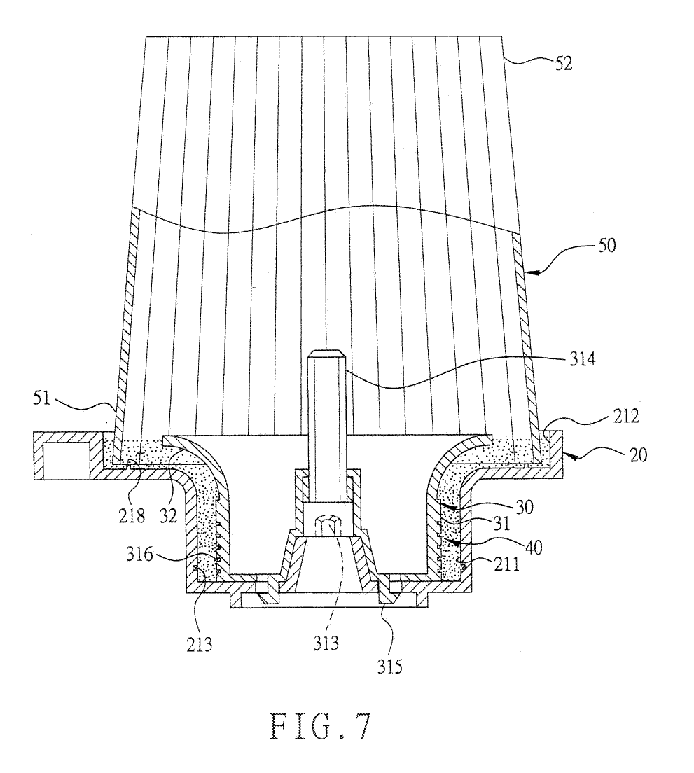

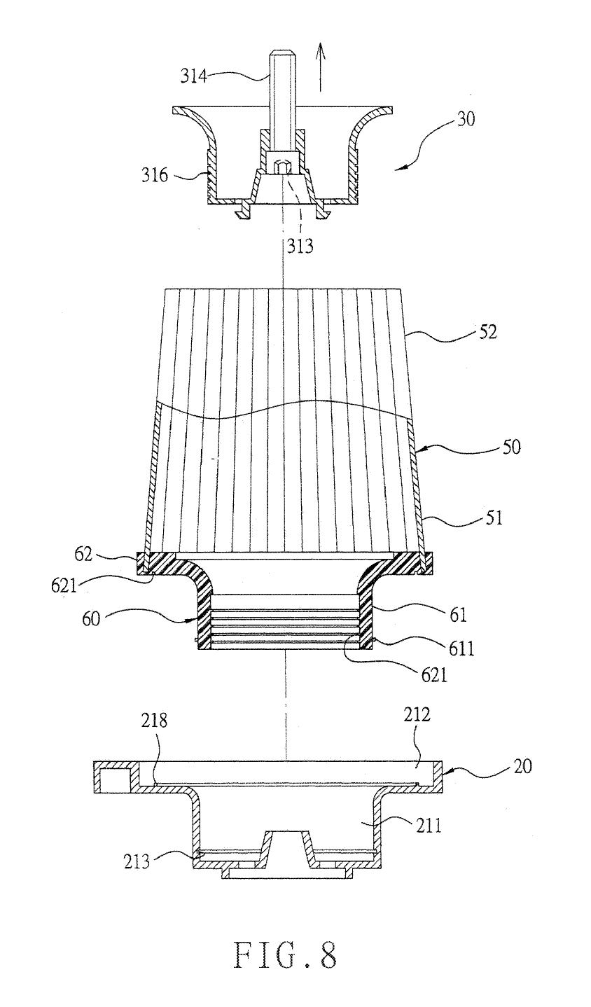

In FIG. 3, when the shaping mold 10 is operated, the core 30 is put into the cavity 21 of the bottom die 20 first, such that the containing opening 311 at the bottom of the core 30 and the tubular mold pillar 214 of the bottom die 20 are engaged with one another. In the meantime, the two positioning blocks 315 of the core 30 are passed into the two the penetrating ditches 216 of the bottom die 20 respectively, a d then the core 30 is turned clockwise as shown in FIGS. 4 and 5 to drive the positioning block 315 to be snapped and positioned in the turn-to-snap slot 217 for installing the core onto the bottom die 20 quickly to close the mold. Now, the low-temperature shaping material such as the liquid silicone 40 or PU foam having a shaping temperature below 100° C. is injected into the gap between the core 30 and the bottom die 20 as shown in FIG. 6. Before the aforementioned low-temperature shaping material is solidified, an opening at the front end of a filter 50 of a motor vehicle or a motorcycle is dipped into the low-temperature shaping material between the cover mold plate 32 and the cover cavity 212, such that after the low-temperature shaping material is condensed and solidified, a tube 61 of a bushing base 60 can be formed between the tube cavity 211 of the bottom die 20 and the tubular mold pillar 31 of the core 30 as shown in FIG. 7, and a cover 62 of the bushing base 60 can be formed between the cover cavity 212 and the cover mold plate 32. In the meantime, the cover 62 can be coupled naturally with the front end 51 of the filter 50 without requiring the glue adhesion operation anymore. An appropriate tool is used for turning the exposed hexagonal bolt hole 313 from the bottom of the bottom die 20 for a disengagement, so that the positioning block 315 of the core 30 can be turned back into the penetrating ditch 216, and an appropriate screwing tool is connected to the bolt 314 at the top of the core 30 to apply a force for an upward movement, so as to remove the whole core 30 by lifting the hollow portion at a rear end 52 of the filter 50 as shown in FIG. 8, and then the filter 50 together with the molded bushing base 60 integrated at the front end 51 of the filter 50 can be removed to complete the demolding process of the whole bushing base 60 easily. With the design of the circular stop groove 213 formed at the periphery of the tube cavity 21 of the bottom die 20 and the circular flange 218 formed on the bottom of the cover cavity 212, a fastener (not shown in the figure) can be formed on the periphery of the tube 61 of the bushing base 60 for tightly pressing a stopping edge 611, and a decorative circular groove 621 is formed on the external wall of the cover 62. With the design of a predetermined number of anti-skid groove 316 disposed on the wall of the tubular mold pillar 31, the corresponding number of anti-skid lines 612 can be formed on the internal wall of the tube 61 of the bushing base 60.

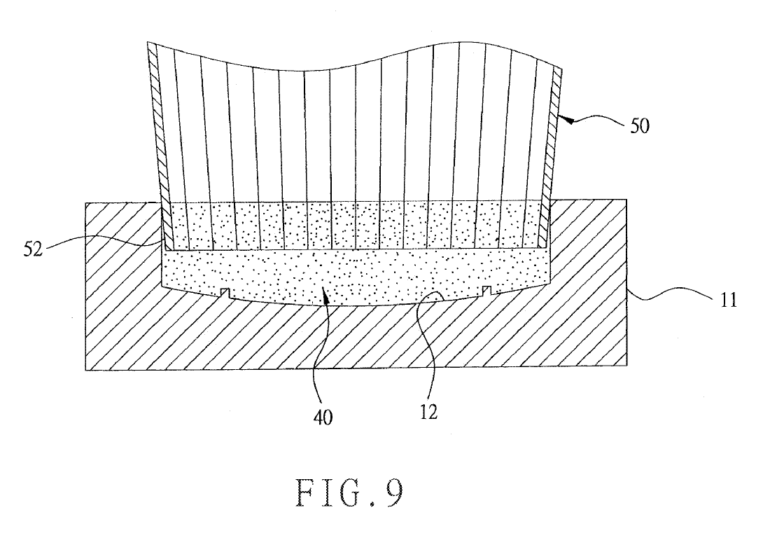

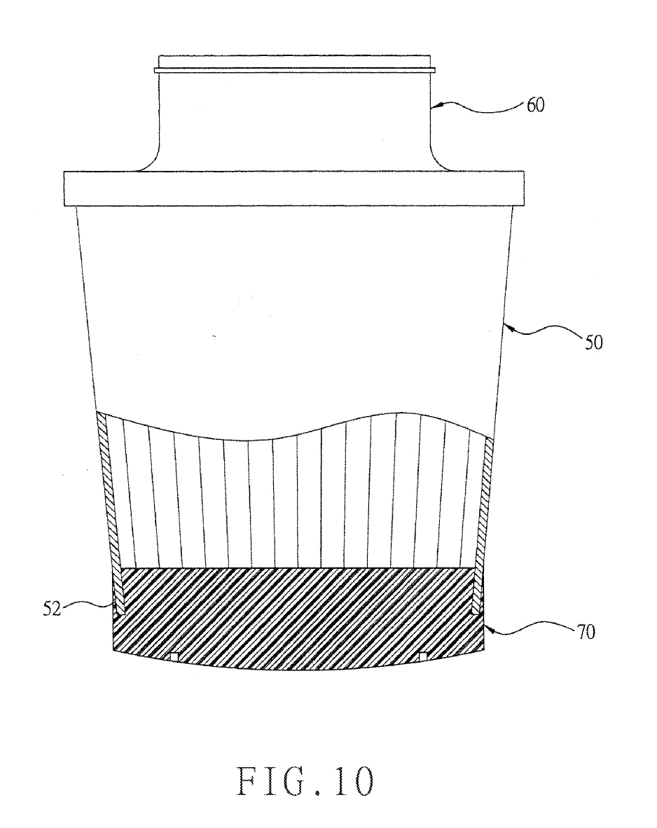

Besides of the application for the bushing base 60 of the front end 51 of the filter of a motor vehicle or a motorcycle, the mold can be modified appropriated for forming a cover 70 at a rear end 52 as shown in FIGS. 9 and 10, wherein a cavity 12 with an external diameter slightly greater than the rear end of the filter 50 is disposed at the center of the shaping mold 11, and then silicone 40 is injected into the cavity 12. After the silicone is condensed and solidified, a cover 70 is formed naturally at the rear end 52.

In summation, the shaping mold 10 of the present invention has the following advantages:

1. The shaping mold 10 of the invention is integrally formed by a heat-resistant plastic material. Since the requirement for the molding technology and the material cost are relatively low, therefore the overall molding cost is much lower than that of a general metal mold, particularly for a mass production that requires a number of molds, the plastic molds can reduce the cost significantly and make the price of the produce more competitive.

2. The shaping mold 10 of the invention comes with a less weight, and the bottom die 20 and the core 30 have the turn-to-snap-in design, and thus both mold closing and molding are easier and quicker than the traditional metal molds.

3. The shaping mold 10 of the invention is formed by a heat-resistant plastic material, and thus the mold closing position has a smoother and finer surface than the metal molds due to the characteristics of the plastic material. Therefore, a bushing base with a smooth and fine surface can be produced.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A shaping mold of a bushing base, comprising:
a bottom die, integrally formed and made of a heat-resistant plastic material, and having a cavity concavely disposed on the bottom die, and a hollow positioning groove disposed at the bottom of the cavity; and
a core, integrally formed and made of a heat-resistant plastic material, and accommodated in the cavity of the bottom die, and a predetermined gap being formed between the core and the cavity and provided for injecting a low-temperature shaping material selected from silicone and polyurethane (PU) foam therein to form the bushing base in a predetermined shape, and a positioning block being protruded from the bottom of the core, for engaging or disengaging with the positioning groove of the bottom die by turning.

2. The shaping mold of a bushing base as recited in claim 1, wherein the cavity of the bottom die includes a tube cavity disposed at the center of the cavity and a cover cavity extended from an opening of the tube cavity and having a diameter greater than the diameter of the tube cavity, and the core includes a tube mold pillar accommodated in the tube cavity, and a greater-diameter cover mold plate extended outwardly from the top of the tube mold pillar and precisely accommodated in the cover cavity, such that when the silicone or PU foam is injected into the gap between the cavity and the core, a tube can be formed between the tube cavity and the tube mold pillar, and a cover can be formed between the cover cavity and the cover mold pillar, and integrally coupled with the tube.

3. The shaping mold of a bushing base as recited in claim 2, wherein the tube cavity includes a circular stop groove concavely disposed around the periphery and proximate to the bottom of the tube cavity for forming a stop edge disposed at a position proximate to a distal portion of an external wall of the tube of the bushing base and provided for a fastener, and a circular flange protruded from a bottom edge of the cover cavity for forming a decorative circular groove around an external edge of the cover of the bushing base.

4. The shaping mold of a bushing base as recited in claim 2, wherein the tube cavity comprises: a tubular mold pillar disposed at the center of the bottom of the tube cavity; two symmetrical hollow positioning grooves disposed at the bottom of the periphery of the tubular mold pillar, and each positioning groove being composed of a penetrating ditch with a wider section and a turn-to-snap slot with a narrower section; a containing opening concavely disposed at the center of the bottom of the tubular mold pillar, and having a hexagonal bolt hole formed at the center of the containing opening and a bolt extended thereon; two symmetrical positioning blocks, extended downwardly from the periphery of the containing opening, and each positioning block being in a form of a claw, and a predetermine number of circular anti-skid grooves formed on an internal wall of the tube mold pillar for forming anti-skid lines on the internal wall of the tube of the bushing base, such that when the core is installed into the cavity of the bottom die, the containing opening is precisely sheathed onto the tubular mold pillar, and the hexagonal bolt hole aligned precisely with a tube hole of the tubular mold pillar is exposed for facilitating a turning movement, and the two positioning blocks can be passed into the penetrating ditches of the positioning groove respectively and turned and snapped into the turn-to-snap slot.

5. The shaping mold of a bushing base as recited in claim 1, wherein the low-temperature shaping material has a shaping temperature below 100° C.
